(19) United States
(12) Patent Application Publication
(10) Pub. No.: US 2013/0046671 A1
(43) Pub. Date: Feb. 21, 2013

(54) WEBSITE FOR ACCUMULATING ORDERS OF FINANCIAL COMMODITIES AND INSTRUMENTS

(71) Applicants: Billson Yang, Taipei City (TW); Simon Shan-Ho Yang, Taipei City (TW); Tony Tung-Yu Yang, Taipei City (TW)

(72) Inventors: Billson Yang, Taipei City (TW); Simon Shan-Ho Yang, Taipei City (TW); Tony Tung-Yu Yang, Taipei City (TW)

(21) Appl. No.: 13/210,389

(22) Filed: Aug. 16, 2011

(51) Int. Cl. G06Q 40/00

(52) U.S. Cl. 705/37

(57) ABSTRACT

A website serves for accumulating orders of financial commodities and instruments. By order accumulation of financial commodities and instruments, a large amount of orders from the investors are accumulated and then by these orders, the investors have the right to negotiate with the financial institutions. Since the amount of the orders is large, the financial institution must increase its services and reduce the fees. The order accumulation of financial commodities and instruments is deemed as a fixed business model with a great coverage. The great amount of the orders will cause the investors to have more profits. The investors of the orders could contract with several financial institutions so as to have joint services from the financial institution. Moreover concept of network center bank currency is disclosed for unifying different kinds of currencies. Thus, the cost for currency exchanging of international business can be reduced.

### FIELD OF THE INVENTION

The present invention relates to a business model and, in particular, to a website for accumulating orders of financial commodities and instruments.

### BACKGROUND OF THE INVENTION

Currently, group purchasing has become a popular e-business model. However, group purchasing is not applied to financial commodities and instruments. Furthermore, current financial commodities and instruments provide fixed transaction conditions which are non-changeable and are non-flexible. Financial institutions are powerful in the transaction conditions. As a result, in this prior business model, consumer's right is suppressed and thus financial institutions do not provide well services to the consumers.

Consumption, deposits, and investments are important for households, businesses, and individuals. The problems induced from consumption have been well resolved through the use of networks, for example, by the order accumulation disclosed by the inventor of the present invention, while non-physical financial commodities and instruments still use the conventional transaction models. It is not improved with the use of networks. In fact, the main scope of financial investments is exchanges of messages and variations of a series of numbers about financial commodities and tools. However the messages are unequal between the financial institutions and the investors. This is a main reason of the financial crisis.

Innocence and greed induce incorrect investments of private investors. The private investors cannot gather together to oppose an unique financial institution. Investors are dispersed and thus the capitals from the retail or private investors can not be well treated. International currency exchanges is uneconomic and is the source of economic crises. As a result, U.S. dollars become the international currency and the global investment institutions are more and more popular, while the private investors are suppressed in the international invest environment and the profits of the private investors are not well protected. One way for resolving this problem is to issue a new electronic currency.

Venture capitals, hedge funds and private equities set limitations to the amount of investing capitals. Thus they are not suitable for private investors. The novel financial commodities created by the financial institutions are aimed to avoid the monitoring of U.S. government, and as a result financial crisis induced from U.S. is spread globally.

Now deposit is full of risk. Banks and wealth have limited lifetime. Although small private capitals could be invested in mutual funds, the mutual funds only charge management fees irrespective of the operation results thereof. They are acceptable as their effects match the variation of indices or markets. In 2007, U.S. people paid about 20 billions to investment institutions and related members, such as lawyers, accountants, etc., but this does not include the profits to these peoples or institutions. These institutions or people control the knowledge and messages of financial investments. They are service providers, keepers, and educators. The private investors are divided as plural individuals. They are weak in financial transaction and are controlled by the financial institutions and related persons. In the practical world, no one has complete information about financial operation and the private investors cannot accumulate to request consumer's right and thus to control the process in financial transaction.

The inventor of the present invention aims to provide a novel method which can accumulate orders of the investors so as to have the power to negotiate with the financial institutions. The so-called order accumulation of financial commodity in the present invention means to gather many orders for buying financial commodities and instruments. Accumulations of orders occur firstly and then financial institutions provide price and service list after the occurrence of the order accumulation. In the present invention, the price and service list is changeable and adjustable based on the order accumulation so that the investors have the right to negotiate about the prices and services of the financial commodity to be transacted in the business process. Furthermore, in the present invention, prices are reduced with the increment of order volume and services are incremented with the increment of the order volume.

### SUMMARY OF THE INVENTION

To achieve the present invention mentioned above, the present invention provides a website for accumulating orders of financial commodities and instruments, wherein by the order accumulation, a large amount of orders from the investors are accumulated and then by these orders, the investors have the right to negotiate with the financial institutions. Since the amount of the orders is large, the financial institution must increase its services and reduce the fees. In the present invention, the order accumulation of financial commodities and instruments is deemed as a fixed business model with a great coverage. The great amount of the orders will cause the investors to have more profits.

To achieve the above object, the present invention provides a website for accumulating orders of financial commodities and instruments, comprising: a central server connected to at least one consumer unit; all operation software and transaction data being stored in the central server; the user can make transactions in different consumer units; the central server including a processor and a memory; the processor serving to process the related actions; the memory serving to store software, operation results and related data; a pre-purchase financial commodity and tool order unit receiving orders of a financial commodity from investor I/O (input/output) device from investors; this order being initially from a first investor and then other investors will join to this action to form an effect of order accumulation; the pre-purchase financial commodity order unit recording the name and quantity of the financial commodity; and a financial institution bidding unit receiving at least one condition from at least one financial institution about the order from the pre-purchase financial commodity and tool order unit; the condition from the financial institutions including at least one of services and profits incremented with the order amount, or risks and fees decremented with the order amount.

The website for accumulating orders of financial commodities further comprises a financial commodity and tool provider database recording the registered financial commodities and tools by their real names and if possible, the network connection; including the financial investing times, items for deposits, insurances, and others; the financial commodity and tool provider database also recording the services and effects; the conditions being provided by the financial institution real time or provided from the financial commodity and tool provider database; a specialist center providing specialized messages to the investors; specialists being erected from the investors or invited externally; suggestions from the specialists being published on website pages which are renewed real time so as to provide as reference to investors for reduction of risk; and a decision center receiving messages from the pre-purchase financial commodity and tool order unit, the financial commodity and tool provider database, the financial institution bidding unit and the specialist center so that the investors make decisions in the decision center; the decision center including preset decision rules as the rules of decision about selections of financial commodity and tool and selection of financial institution.

Various embodiments and advantages will be more readily understood from the following detailed description when read in conjunction with the appended drawings.

### BRIEF DESCRIPTION OF THE DRAWINGS

FIG. 1 shows the hardware structure of the present invention.

FIG. 2 is a block diagram of the financial commodity and tool accumulation of the present invention.

FIG. 3 is a block diagram about a first application of the present invention.

FIG. 4 is a block diagram about the second application of the present invention.

FIG. 5 is a block diagram about the third application of the present invention.

FIG. 6 shows a block diagram about the fifth application of the present invention.

FIG. 7 shows a block diagram about the sixth application of the present invention.

FIG. 8 shows a block diagram about the seventh application of the present invention.

### DETAILED DESCRIPTION OF THE INVENTION

In order that those skilled in the art can further understand the present invention, a description will be provided in the following in details. However, these descriptions and the appended drawings are only used for those skilled in the art to understand the objects, features, and characteristics of the present invention, but not to be used to confine the scope and the spirit of the present invention defined in the appended claims.

In order for those skilled in the art can further understand the present invention, a description will be provided in the following in details. However, these descriptions and the appended drawings are only used for those skilled in the art to understand the objects, features, and characteristics of the present invention, but not to be used to confine the scope and spirit of the present invention defined in the appended claims.

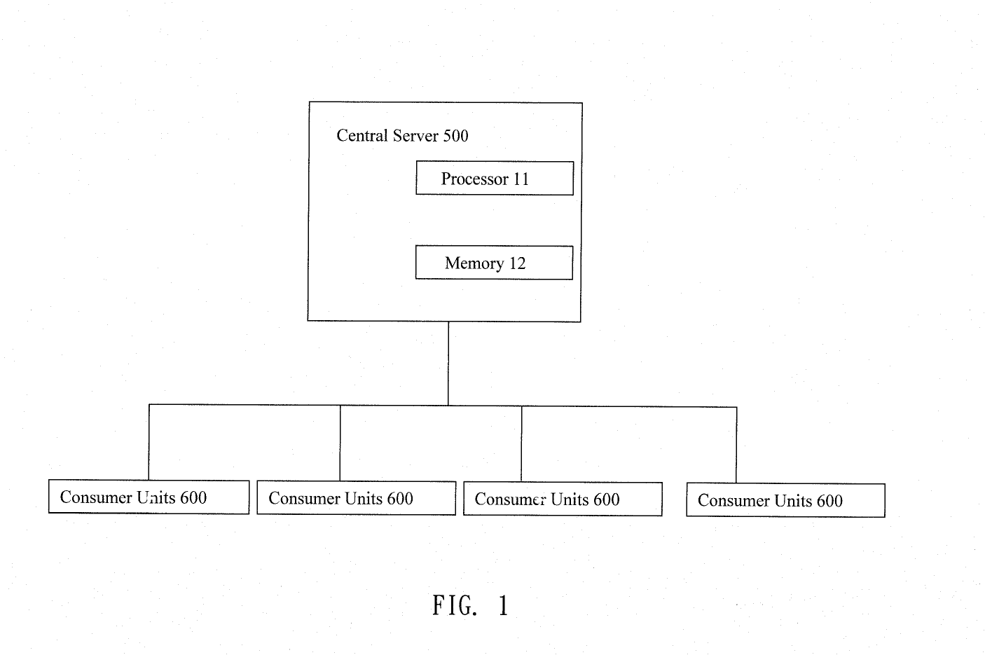

With reference to FIG. 1, the hardware structure of a central server 500 of the present invention is illustrated. The central server 500 is connected to at least one consumer unit 600 through, for example, Internet Explorer. In the present invention, all the operation software and the transaction data is stored in the central server 500. The user can make transactions in different consumer units 600. The central server 500 includes a processor 11 and a memory 12. The processor 11 serves to process the related action of the present invention. The memory 12 serves to store the software, the operation results and related data of the present invention.

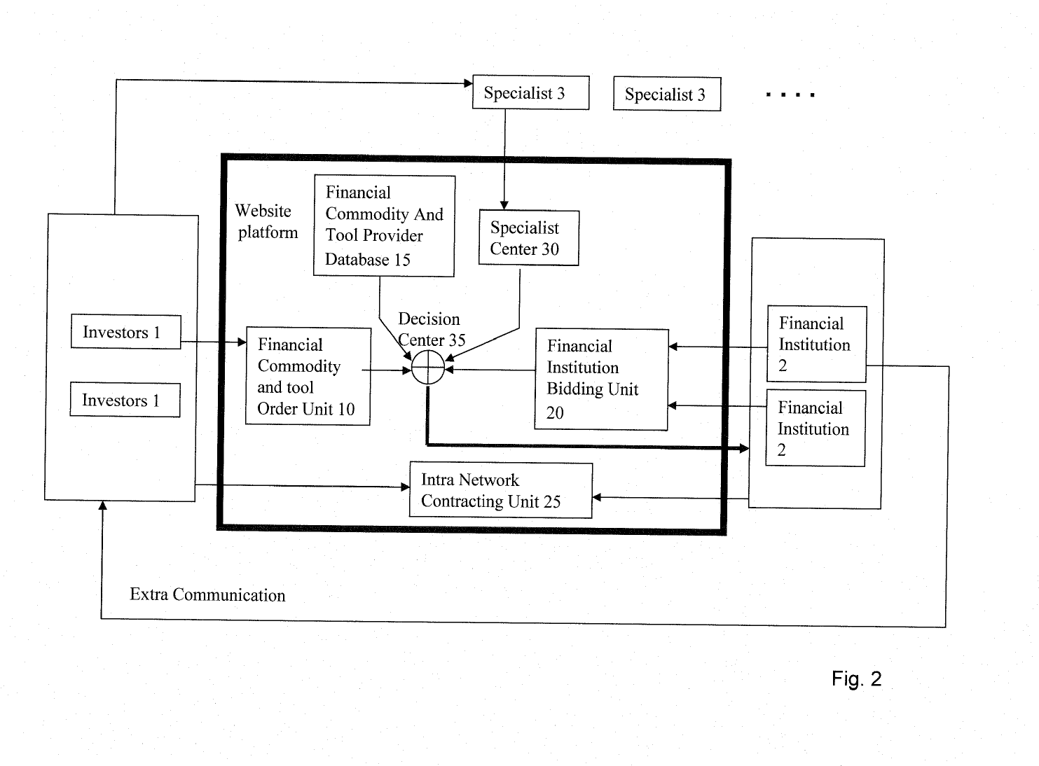

Referring to FIG. 2, the mechanism and structure about the order accumulation of financial commodities and tools of the present invention is illustrated. The present invention includes the following elements.

A pre-purchase financial commodity and tool order unit 10 receives the orders of a financial commodity from investor I/O (input/output) device (in the following, it is called as investor) from investors. This order is initially from a first investor 1 and then other investors 1 will join to this action so as to form an effect of order accumulation. The pre-purchase financial commodity and tool order unit 10 records the name and quantity of the financial commodity and tool. The pre-purchase financial commodity and tool can be inputted by keywords.

In the present invention, the investor 1 may be an individual, an organization, a corporation, an unit, etc. They must register to the website by the real name. The financial commodity and tool may be a commodity of a venture fund, a stock, a future, etc. including foreign investments and domestic investments and also including the details and amounts of money. The investors 1 must input the periods and kinds of currencies about the deposits, insurances, credit cards, or debts, etc. for order accumulation by the website of the present invention.

A financial commodity and tool provider database 15 records all the registered financial commodities by their real names and if possible, the network connection; including the financial investing times, such as items for deposits, insurances, and others; and the financial commodity and tool provider database 15 also recording the services and effects. These recorded data may be set to be displayed automatically or passively. The automatic display is displayed on a financial commodity and tool list (not shown) of the website to be selected by the investors. The passive display means the financial commodity is displayed only when the investor 1 inputs orders related to the financial commodity.

A financial institution bidding unit 20 receives the conditions from at least one financial institution 2 about the order from the pre-purchase financial commodity and tool order unit 10. The conditions are provided by the financial institution 2 real time or provided from the financial commodity provider database 15. In the present invention, the financial institution 2 is one of banks, investment advisories, insurance companies, future businesses, dealers, e-business providers, etc. The conditions from the financial institutions 2 are services or profits which increment with the order amount, or risks or fees which decrement with the order amount.

A specialist center 30 provides specialized messages to the investors 1. The specialists are elected from the investors 1 or invited externally by the website. The suggestions from the specialists are published on the website pages which are renewed real time so as to provide references to investors 1 for reduction of risk. Furthermore, the website provides SNS (social network system) to the investors 1 for discussion and making friends.

A decision center 35 receives messages from the pre-purchase financial commodity and tool order unit 10, the financial commodity and tool provider database 15, the financial institution bidding unit 20 and the specialist center 30 so that the investors 1 make decisions in the decision center 35. The decision center 35 includes preset decision rules as the rules of decision about the selection of financial commodity and financial institution 2.

In the decision center 35, after evaluations from the specialist center 30, if the website manage considers that the conditions from the financial institutions 2 are low profits, or high risks, or the financial institutions 2 forming a monopoly combination, the website managers can cancel the orders or disclose the defects of this order to the investors to affect decisions and voting of the investors 1.

An intra network contracting unit 25 is provided for contracting between the investors 1 and the voted financial institutions 2 in the website of the present invention.

However extra-network contact is also permissible, for example, in different areas, the contracting work can be done by official permissible institutions.

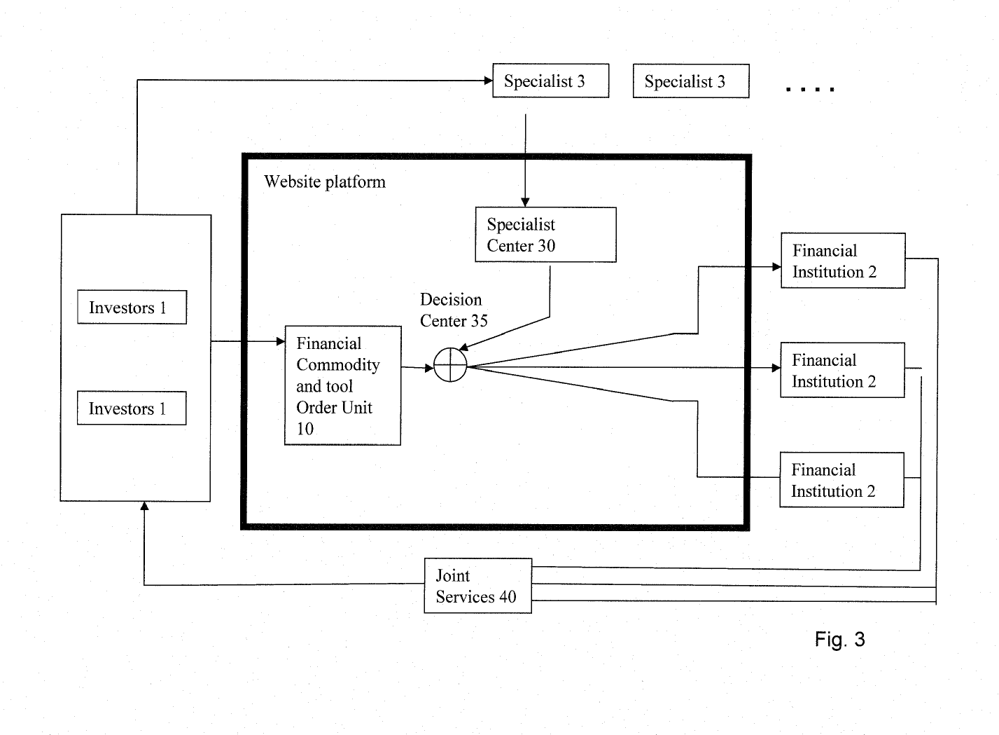

Referring to FIG. 3, an application of the present invention is illustrated. In this application, the present invention is applied to the order accumulation of deposits. That is the financial commodity in the pre-purchase financial commodity and tool order unit 10 is deposits. The orders of deposits are accumulated from the investors 1 to accumulate a great amount of deposits. As referring to FIG. 3, in this embodiment, under consideration of profits, insurances and quality of services, the deposits are distributed to several financial institutions 2. Furthermore, under this construction, the website requests that all the financial institutions 2 must provide joint services 40 and less service fees to the investors 1. Thus, the investors can withdraw money from anyone of these financial institutions and the service fees can be cancelled or reduced. As a result, cost is reduced. Furthermore, more services can be provided from anyone of these financial institutions, such as managements of capitals, usage of safe deposit boxes, etc.

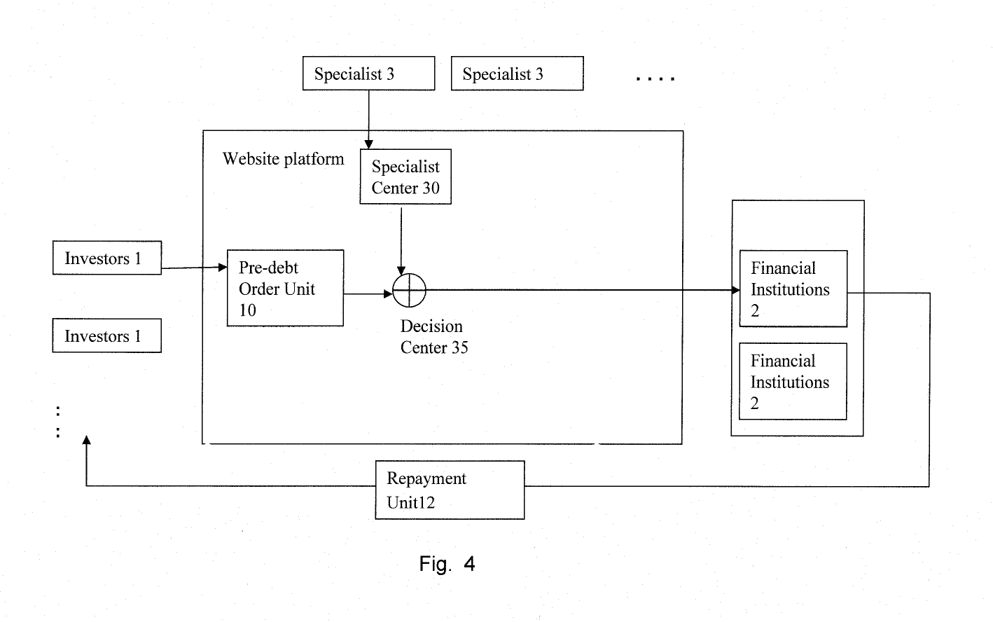

Referring to FIG. 4, another application of the present invention is illustrated. In this embodiment, the debts are accumulated. This is the pre-purchase financial commodity and tool order unit 10 is now a pre-debt order unit 10. Thus the debtors (investors at this invention) can borrow money from the financial institutions 2 or invest bonds to reduce the cost through the order accumulation of the present invention. Furthermore, the present invention further has a repayment unit 12 (or a guarantee unit) for repaying (or guaranteeing) by salaries, interests, stock options, etc.

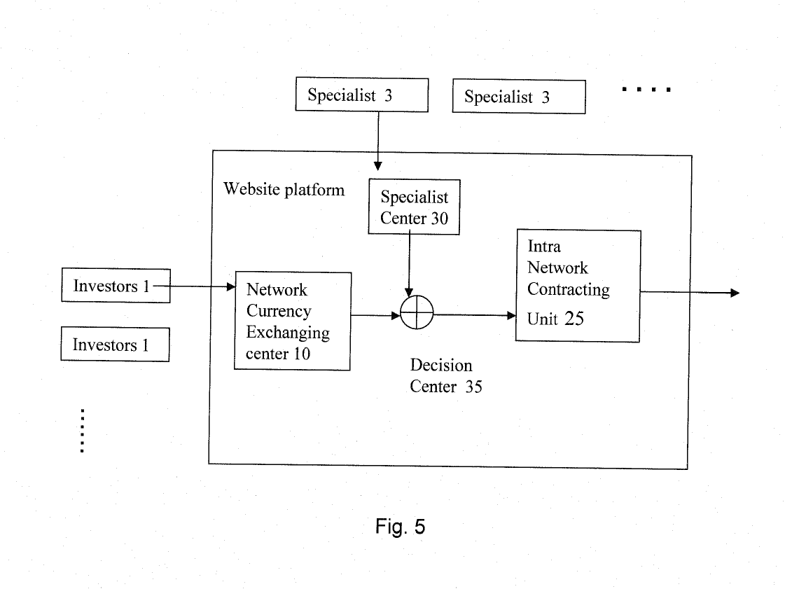

With reference to FIG. 5, another application of the present invention is illustrated. In this application, a network central bank can be built by the present invention. By the present invention, the pre-purchase financial commodity and tool order unit 10 is a network currency exchanging center 10 for exchanging local currencies into a network central bank currency which can be used in different areas through the website of the present invention. By this application of the present invention, a large amount of network central bank currency can be accumulated so as to have a powerful function in consuming, depositing, investing and borrowing. The effect of the network central bank currency is more powerful than the credit cards.

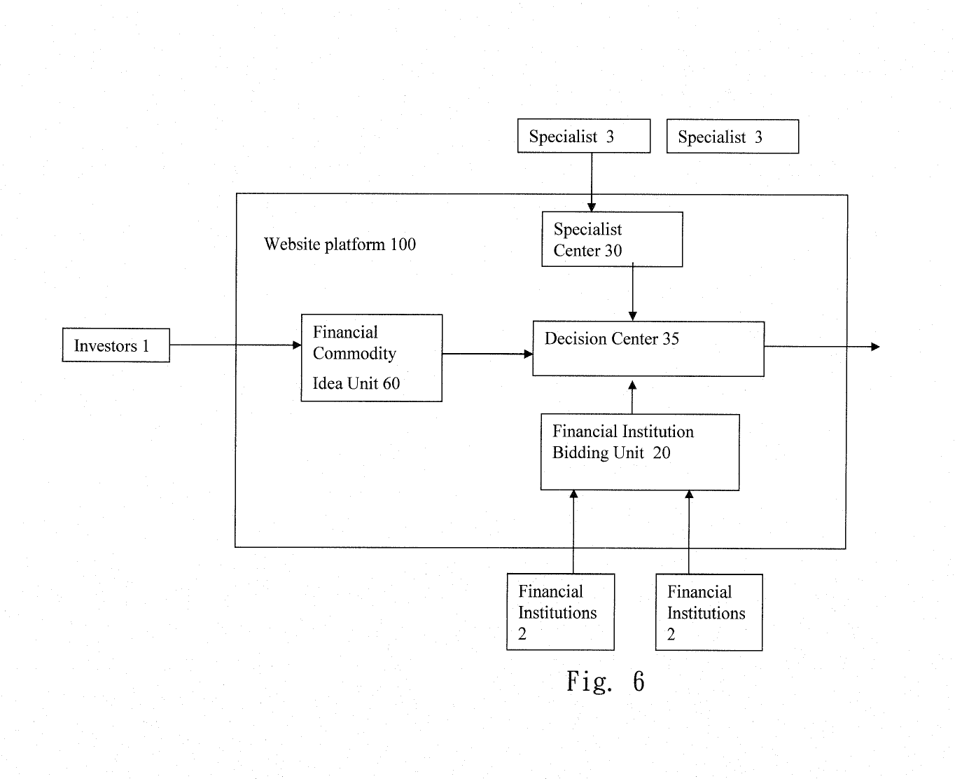

Referring to FIG. 6, a further application of the present invention is shown. A financial commodity idea unit 60 is built in this application. By this unit, investors 1 can create an idea of a financial commodity through the financial commodity idea unit 60 and then the idea is transferred to the decision center 35. After the idea is evaluated by specialists, the financial institutions 2 can bid the right for performing these ideas through the financial institution bidding unit 20.

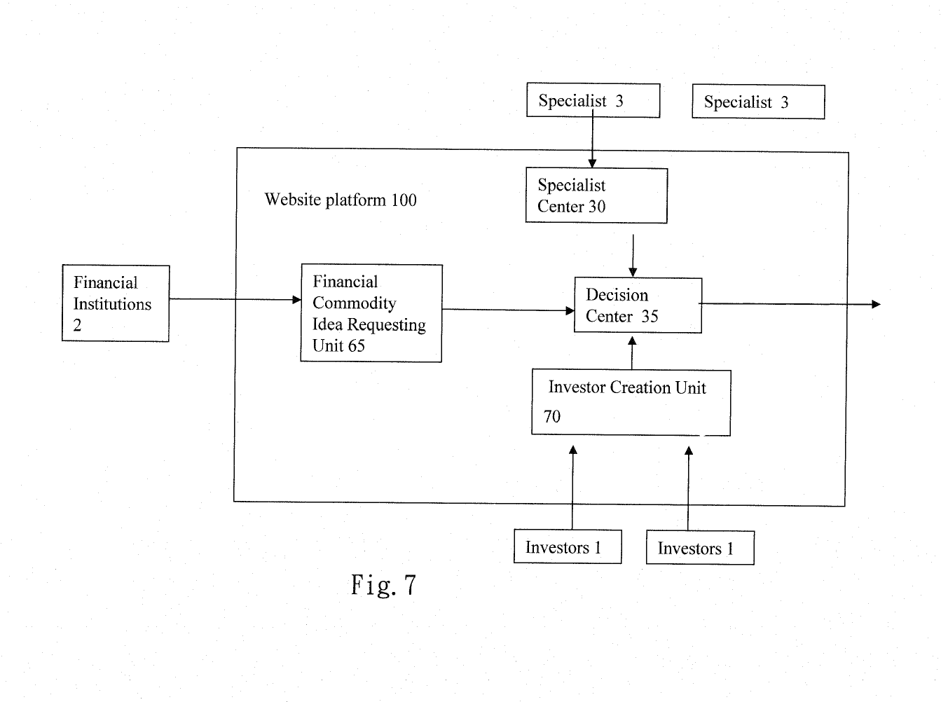

With reference to FIG. 7, yet an application of the present invention is shown. In that, a financial commodity idea requesting unit 65 is provided, by which, the financial institutions 2 can list conditions for a desired financial commodity which is then transferred to the decision center 35. After evaluating through the specialists, the investors 1 can disclose the idea matching to the conditions for the desired financial commodity through an investor creation unit 10. Then the idea is transferred to the decision center 35 to be selected by the financial institutions 2.

Another mechanism of the present invention is to provide a charity function. The website provides the function of charity for the investors and the financial institutions 2 as the profits of them is over a preset percentage. The website provides the lists of those who need to be assisted.

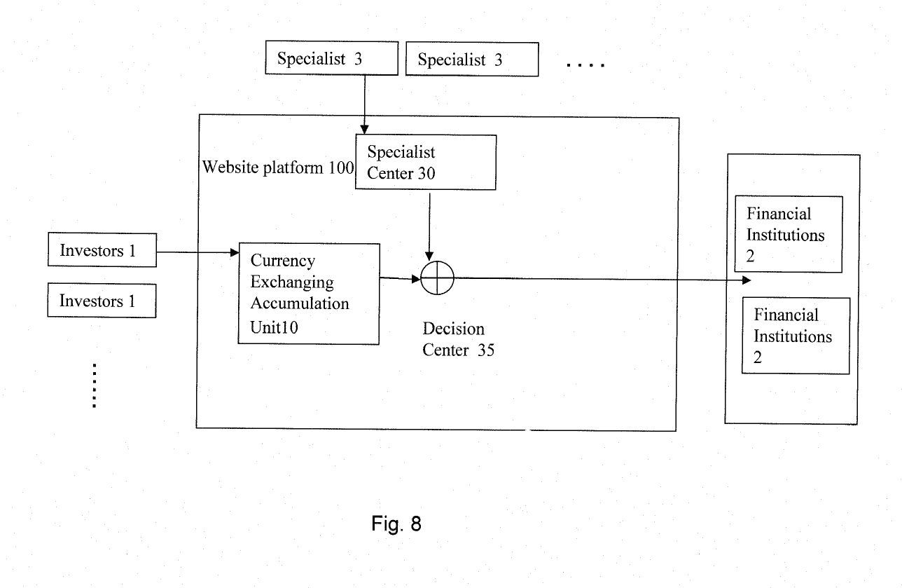

Referring to FIG. 8, another application of the present invention is illustrated. In this structure, a currency exchanging accumulation unit 10 (that is one kind of the pre-purchase financial commodity order unit 10) is provided. By this unit, the currency exchanging can be performed through this platform of the website. Since the amount of currency to be exchanged is accumulated to a large one, it will enforce the financial institution 2 to reduce the rate of currency exchange.

The difference between the order accumulation of the present invention and the prior group purchase will be described in the following.

The price and quantity relation of a commodity in the conventional group purchasing are determined by the sellers. However in the order accumulation of the present invention, the buyers accumulate the orders and the sellers bid the right for providing the commodity. In the process, the prices are changeable based on the sales volume. The process of the present invention is reversed to that of prior group purchasing. Because there are many bidding sellers, the buyers have more selection ways.

Advantages of the present invention are that: the prior financial commodity is provided by the financial institutions with preset conditions and then the investors buy the financial commodities. The investors have no right to discuss the selling conditions with the financial institutions. In the present invention, by the order accumulation, a large amount of orders from the investors are accumulated and then by these orders, the investors have the right to negotiate with the financial institutions. Since the amount of the orders is large, the financial institution must increase its services and reduce the fees. In the present invention, the order accumulation of financial commodities and instruments is deemed as a fixed business model with a great coverage. The great amount of the orders will cause the investors to have more profits.

However the investors of the orders can be contracted with several financial institutions so that these financial institutions will provide joint services to the investors. It is convenient to the investors. The network central bank currency is helpful to the unity of different kinds of currencies. Furthermore, the cost about currency exchanging of international business can be reduced.

Furthermore, in the present invention, the financial institutions need to provide the services and profits with increment with the order amount, or risk and fees which decrement with the order amount, as a result the consumer's right is enlarged.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A system for accumulating orders of financial commodities and tools in a website platform, comprising:
a pre-purchase financial commodity and tool order unit receiving orders of a financial commodity from an investor I/O (input/output) device; the pre-purchase financial commodity and tool order unit accumulating the orders initially from a first investor and then other investors; the pre-purchase financial commodity order and tool unit recording the name and quantity of the financial commodity; and
a financial institution bidding unit receiving at least one condition from at least one financial institution and about the order from the pre-purchase financial commodity and tool order unit; the condition from the financial institutions being at least one of; services, profits, risks, and fees; in that the services and profits are incremented with the amount of the order, and the risks and fees are decremented with the amount of the order; and
wherein the pre-purchase financial commodity and tool order unit and the financial institution bidding unit are constructed in a central server which is connected to at least one consumer unit; the investors can make transactions in different consumer units connected to the server; the central server including a processor and a memory.

2. The system as claimed in claim 1, further comprising:
a financial commodity and tool provider database recording the registered financial commodities and tools with real names of the providers, financial investing times, items for deposits, insurances, services and effects;
the conditions being provided by the financial institution or provided from the financial commodity and tool provider database;
a specialist center providing specialized messages to the investors; and publishing suggestions from specialists on website pages of the website platform as reference to investors for reduction of risk; and
a decision center receiving messages from the pre-purchase financial commodity and tool order unit, the financial commodity and tool provider database, the financial institution bidding unit and the specialist center and the decision center receiving decisions from the investors; the decision center including preset decision rules as the rules of decision about selections of financial commodity and tool and selection of financial institutions.

3. The system as claimed in claim 2, further comprising:
an intra network contracting unit for contracting between the investors and the selected financial institutions.

4. The system as claimed in claim 2, further comprising a table for listing registration from the investor; including inputs from the investors about kinds of currencies about the deposits, insurances, credit cards, or credits for order accumulation; and the financial institution responds to the order by practical or non-practical financial commodity with a form of spot goods or futures.

5. The system as claimed in claim 2, wherein the pre-purchase financial commodity and tool order unit receives the order from the financial commodity by inputting of keywords and the financial institution bidding unit receives financial commodities related to the keywords from the financial institution for being selected by the investors.

6. The system as claimed in claim 2, wherein the financial commodity and tool provider database displays data therein automatically or passively.

7. The system as claimed in claim 2, wherein the financial institution is one of banks, investment advisories, insurance companies, future businesses, dealers, and e-business providers.

8. The system as claimed in claim 2, wherein the platform provides SNS (social network system) to the investors for mutual discussions and making friends.

9. The system as claimed in claim 2, wherein the decision center provides a function of selecting a plurality of financial institutions as transaction objects so that these financial institutions provides joint services to the investors.

10. The system as claimed in claim 2, wherein the pre-purchase financial commodity order unit is a network currency exchanging center for exchanging local currencies into a network central bank currency which can be used in different areas through the platform.

11. The system as claimed in claim 2, further comprising a financial commodity idea unit for receiving ideas about financial commodities transferring the idea to the decision center; and deciding a financial institution for performing the idea after the idea is evaluated.

12. The system as claimed in claim 2, further comprising
a financial commodity idea requesting unit for receiving conditions for a desired financial commodity from the financial institutions and then transferring the conditions to the decision center to be evaluated by specialists;
an investor creation unit receiving ideas mating to the conditions from investors after the conditions are evaluated by the specialists; and the investor creation unit further transferring the idea to the decision center to be selected by the financial institutions.

13. The system as claimed in claim 2, wherein an order is cancelled if the order are low profits, or high risks, or the financial institutions forming a monopoly.

14. The system as claimed in claim 2, wherein the pre-purchase financial commodity order unit is a deposit accumulating unit for accumulating orders of deposits to accumulate to a great amount; the deposit accumulating unit further distributing the deposits several financial institutions for requesting all the financial institutions to provide joint services for reduction of service fees.

15. The system as claimed in claim 4, wherein the pre-purchase financial commodity order unit is a pre-debt order unit for borrowing money from the financial institutions or invest bonds; the website platform further comprises a guaranteed unit in that salaries, interests, stock options are guaranteed.
